(19) United States
(12) Patent Application Publication
(10) Pub. No.: US 2014/0249848 A1
(43) Pub. Date: Sep. 4, 2014

(54) DEFINING PATIENT EPISODES BASED ON HEALTHCARE EVENTS

(71) Applicant: 3M Innovative Properties Company, (US)

(72) Inventors: Richard F. Averill, Seymour, CT (US); Jon Eisenhandler, Bristol, CT (US); David E. Gannon, Waterford, CT (US); Anthony J. Quain, Alexandria, VA (US); James A. Switalski, Cheshire, CT (US); James C. Vertrees, Annapolis, MD (US)

(73) Assignee: 3M INNOVATIVE PROPERTIES COMPANY, ST. PAUL, MN (US)

(21) Appl. No.: 13/782,487

(22) Filed: Mar. 1, 2013

(51) Int. Cl. G06F 19/00; G06Q 50/24

(52) U.S. Cl. CPC G06F 19/3487; G06Q 50/24
USPC 705/3

(57) ABSTRACT

In one example, this disclosure describes a method of processing healthcare data via one or more computers. The method may comprise receiving dated patient healthcare including information about diagnosed conditions, delivered services or procedures, severity indicators, or resource utilization. The method may further comprise determining trigger healthcare service events based on the patient healthcare data. Trigger healthcare service events may comprise inpatient admissions, outpatient procedures, or outpatient healthcare services. After determined any trigger healthcare service events, the method may include determining one or more temporally non-overlapping healthcare service events based on any determined trigger healthcare service events.

### TECHNICAL FIELD

The invention relates to categorization of healthcare events.

### BACKGROUND

In the healthcare field, patient interactions with healthcare facilities are generally defined around treatment for diagnosed diseases or other health problems. Indeed, the amount of money a payor, such as insurance companies or Medicare or Medicaid, will reimburse healthcare facilities and healthcare professionals is generally based on the specific services provided to treat a patient for a specific disease or health problem. However, inaccuracies can arise with defining interactions and reimbursement around specific diseases or health problems. For example, in cases where a patient is treated for multiple diseases or health problems, it is often difficult to categorize the services performed as relating to only one of the diseases or health problems, as the disease progressions are inter-related and the treatment for one disease often impacts the severity or progression of the other diseases.

### SUMMARY

This disclosure describes systems and techniques for processing healthcare data via one or more computers. The techniques and systems described herein can help to break patient healthcare events into defined healthcare service episodes. By defining patient healthcare events by healthcare service episodes, the system and techniques may help to accurately determine past resource utilization and estimate future resource utilization. This information may be useful to payors for setting reimbursement rates for healthcare professionals and healthcare facilities.

In one example, this disclosure describes a method of processing healthcare data via one or more computers. The method comprises receiving, at the one or more computers, dated patient healthcare data associated with a patient, wherein the dated patient healthcare data comprises information about one or more of diagnosed conditions, delivered services or procedures, severity indicators, or resource utilization data associated with any delivered services or procedures, determining, via the one or more computers, trigger healthcare service events based on the patient healthcare data, wherein the trigger healthcare service events comprise one or more of inpatient admissions, outpatient procedures, or outpatient healthcare services, and determining, via the one or more computers, one or more temporally non-overlapping healthcare service episodes based on the determined trigger healthcare service events.

In another example, this disclosure describes a computerized healthcare system for processing healthcare data, the system comprising a computer that includes a processor and a memory, wherein the processor is configured to receive dated patient healthcare data associated with a patient, wherein the dated patient healthcare data comprises information about one or more of diagnosed conditions, delivered services or procedures, severity indicators, or resource utilization data associated with any delivered services or procedures, determine trigger healthcare service events based on the patient healthcare data, wherein the trigger healthcare service events comprise one or more of inpatient admissions, outpatient procedures, or outpatient healthcare services, and determine one or more temporally non-overlapping healthcare service episodes based on the determined trigger healthcare service events.

In another example, this disclosure describes a device for processing healthcare data. In this example, the device comprises a means for receiving, at the one or more computers, dated patient healthcare data associated with a patient, wherein the dated patient healthcare data comprises information about one or more of diagnosed conditions, delivered services or procedures, severity indicators, or resource utilization data associated with any delivered services or procedures, means for determining, via the one or more computers, trigger healthcare service events based on the patient healthcare data, wherein the trigger healthcare service events comprise one or more of inpatient admissions, outpatient procedures, or outpatient healthcare services, and means for determining, via the one or more computers, one or more temporally non-overlapping healthcare service episodes based on the determined trigger healthcare service events.

The techniques of this disclosure may be implemented at least partially in hardware, such as a processor or discrete logic circuits. The techniques may also be implemented using aspects of software or firmware in combination with the hardware. If implemented at least partially in software or firmware, the software or firmware may be executed in one or more hardware processors, such as a microprocessor, application specific integrated circuit (ASIC), field programmable gate array (FPGA), or digital signal processor (DSP). The software that executes the techniques may be initially stored in a computer-readable storage medium and loaded and executed in the processor. The processor may execute modules to perform the techniques of this disclosure, and the modules may comprise combinations of software and hardware, e.g., software routines executing on the processor.

Accordingly, this disclosure also contemplates a computer-readable storage medium comprising instructions that when executed in a processor cause the processor to process healthcare data, wherein upon execution, the instructions cause the processor to receive dated patient healthcare data associated with a patient, wherein the dated patient healthcare data comprises information about one or more of diagnosed conditions, delivered services or procedures, severity indicators, or resource utilization data associated with any delivered services or procedures, determine trigger healthcare service events based on the patient healthcare data, wherein the trigger healthcare service events comprise one or more of inpatient admissions, inpatient or outpatient procedures, or outpatient healthcare services, and determine one or more temporally non-overlapping healthcare service episodes based on the determined trigger healthcare service events.

The details of one or more embodiments of the invention are set forth in the accompanying drawings and the description below. Other features, objects, and advantages of the invention will be apparent based on the description and drawings, and based on the claims.

### BRIEF DESCRIPTION OF DRAWINGS

FIG. 1 is a block diagram illustrating an example of a stand alone computer system for determining healthcare service episodes consistent with this disclosure.

FIG. 2 is another block diagram illustrating an example of a stand alone computer system for determining healthcare service episodes consistent with this disclosure.

FIG. 3 is a diagram illustrating an example patient profile including multiple healthcare service episodes.

FIG. 4 is a block diagram illustrating an example of a distributed system for determining patient episodes consistent with this disclosure.

FIG. 5 is a flow diagram illustrating a technique of this disclosure.

FIG. 6 is a flow diagram illustrating a technique of this disclosure.

FIG. 7 is a flow diagram illustrating a technique of this disclosure.

FIG. 8 is a flow diagram illustrating a technique of this disclosure.

### DETAILED DESCRIPTION

This disclosure describes systems and techniques for determining healthcare service episodes via one or more computers. The systems and techniques may be used by a healthcare payor, such as a healthcare insurance company or Medicare and Medicaid, to establish reimbursement rates for healthcare professionals and healthcare facilities based on particular healthcare service episodes. In other instances, the systems and techniques may be used by healthcare professionals and facilities to estimate a reimbursement amount they expect to receive from a payor for treatment of one or more patients.

Currently, many systems for assisting in establishing reimbursement rates set the rates based on diagnosed diseases or other health problems. For instance, a payor may reimburse healthcare professionals and facilities a set amount based on a diagnosis of a broken forearm. This reimbursement amount is generally estimated to cover the resources utilized during treatment surrounding mending the broken arm. In other current systems, a payor may reimburse healthcare professionals and facilities based on treatment actually given, up to a set limit. These rates or limits are generally established so as to encourage efficient utilization of healthcare resources. However, establishing these rates or limits can become complicated for patients with multiple diagnosed diseases, conditions or other health problems. For instance, treatment for one disease or health problem may also help treat, or in some cases worsen, other diseases or health problems. This problem adds to the complexity for establishing reimbursement budgets or limits on treatment for particular diseases or health problems.

In contrast to the various current methods, the systems and techniques described herein break patients down into specific healthcare service episodes. In particular, rather than grouping treatment based on disease, healthcare service episodes are defined time periods and include all healthcare events occurring within the defined time period. In the case of a broken forearm, for example, the healthcare service episode might include the inpatient admission for diagnosis and treatment for the broken arm, along with any pain medication prescribed. Further, the healthcare service episode may include a follow-up outpatient visit for monitoring the healing and removing of the cast. In this manner, healthcare service episodes do not group healthcare events based on their relevance to various diseases, but rather around specific periods of time. In the situation of multiple diseases, there is not a need to break down which healthcare event belongs to which disease or health problem because all the healthcare events are captured within the defined healthcare service episode. Furthermore, payors may then look at healthcare service episodes to determine the overall level of resource utilization during the episode and may compare similar episodes across patients to determine comparable resource utilization and establish reimbursement rates based on such data. Healthcare professionals and facilities may also use the systems and methods described herein to estimate a reimbursement amount, thereby allowing them to operate efficiently and within the reimbursement amounts set by the payors.

As described in greater detail below, the methods of this disclosure may be performed by one or more computers. The methods may be performed by a stand alone computer, or may be executed in a client-server environment in which a user views the healthcare service episodes or resource utilization data at a client computer. In the later case, the client computer may communicate with a server computer. The server computer may store the patient healthcare data and apply the techniques of this disclosure to determine episodes or determine resource utilization and output the results to the client computer.

In one example, a method includes receiving, at the one or more computers, dated patient healthcare data associated with a patient, wherein the dated patient healthcare data comprises information about one or more of diagnosed conditions, delivered services or procedures, severity indicators, or resource utilization data associated with any delivered services or procedures. The method may further include determining, via the one or more computers, trigger healthcare service events based on the patient healthcare data, wherein the trigger healthcare service events comprise one or more of inpatient admissions, outpatient procedures, or outpatient healthcare services. After determining trigger healthcare service events, the method may determine, via the one or more computers, one or more temporally non-overlapping healthcare service episodes based on the determined trigger healthcare service events.

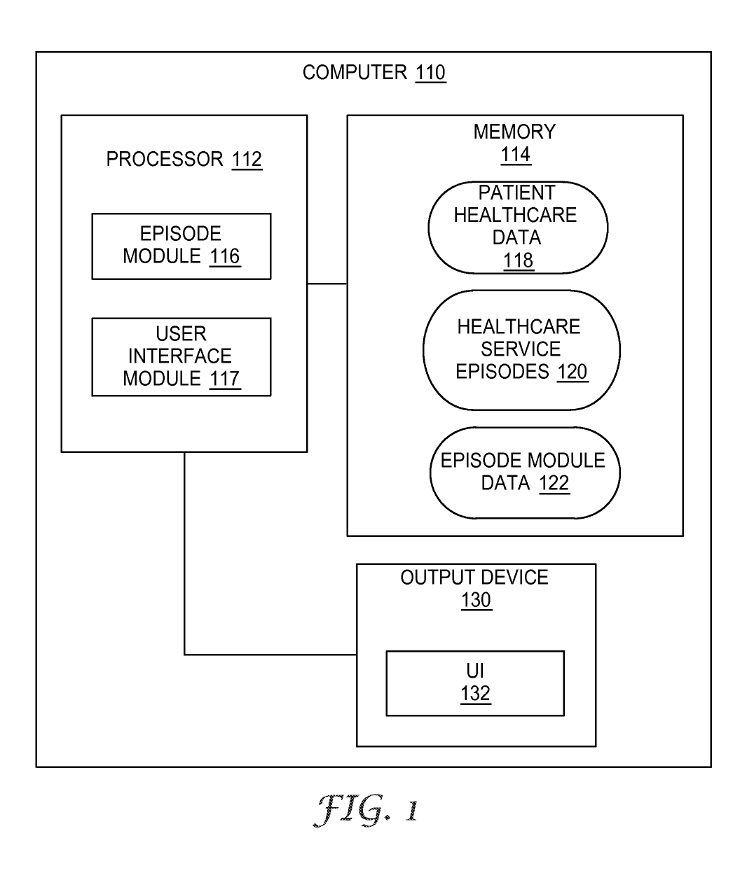

FIG. 1 is a block diagram illustrating an example of a stand-alone computerized system for determining healthcare service episodes consistent with this disclosure. The system comprises computer 110 that includes a processor 112, a memory 114, and an output device 130. Computer 110 may also include many other components. The illustrated components are shown merely to explain various aspects of this disclosure.

Output device 130 may comprise a display screen, although this disclosure is not necessarily limited in this respect, and other types of output devices may also be used. Memory 114 includes patient healthcare data 118, which may comprise data collected in documents such as patient healthcare records, among other information. Memory 114 may further include healthcare service episodes 120 and episode module data 122. Processor 112 is configured to include a user interface module 117 and an episode module 116 that executes techniques of this disclosure with respect to patient healthcare data 118, and in some cases, episode module data 122. In some examples, episode module data 122 may comprise information such as which healthcare service events are trigger healthcare service events. In other examples, episode module data 122 may comprise a series of predefined rules identifying trigger healthcare service event priorities, described in further detail below. In still other examples, episode module data 122 may comprise predefined episode window time periods, also described in further detail below.

Processor 112 may comprise a general-purpose microprocessor, a specially designed processor, an application specific integrated circuit (ASIC), a field programmable gate array (FPGA), a collection of discrete logic, or any type of processing device capable of executing the techniques described herein. In one example, memory 114 may store program instructions (e.g., software instructions) that are executed by processor 112 to carry out the techniques described herein. In other examples, the techniques may be executed by specifically programmed circuitry of processor 112. In these or other ways, processor 112 may be configured to execute the techniques described herein.

Output device 130 may comprise a display screen, and may also include other types of output capabilities. In some cases, output device 130 may generally represent both a display screen and a printer in some cases. Episode module 116, and in some cases in conjunction with communication module 117, may be configured to cause output device 130 to output patient healthcare data 118, healthcare service episodes 120, or other data. In some instances, output device 130 may include a user interface (UI) 132. UI 132 may comprise an easily readable interface for displaying the output information. Outputting patient healthcare data 118, healthcare service episodes 120, or other data may assist payors in determining patient episodes and further determining or estimating resource utilization associated with patient episodes.

In one example, episode module 116 receives patient healthcare data 118. Patient healthcare data 118 may include information included in a patient healthcare record or any other documents or files describing a patient encounter with a healthcare facility. For example, when a patient has an encounter with a healthcare facility, such as during an inpatient admission or an outpatient visit, all of the information gathered during the encounter and preceding the encounter may be consolidated into a patient healthcare record. In one example, such a patient healthcare record may include any procedures performed, any medications prescribed, any notes written by a physician or nurse, and generally any other information concerning the patient encounter with the healthcare facility. Further, patient healthcare data 118 may also include information from healthcare claims forms. Each piece of information included in patient data 118 may further be associated with a particular date. For example, patient healthcare data 118 may include multiple pieces of information associated with an inpatient admission event occurring on Mar. 20^{th}, 2005. In such an example, each piece of information related to that inpatient admission event may further be associated with the date Mar. 20^{th}, 2005 (or other relevant date if all the services or procedures relating to the inpatient admission did not occur on that exact date).

Patient healthcare data 118 may further include one or more standard healthcare codes. In some examples, the patient healthcare records or the healthcare claims forms may include one or more of these standard healthcare codes, which generally may describe the services and procedures delivered to a patient. Examples of such healthcare codes include codes associated with the International Classification of Diseases (ICD) codes (versions 9 and 10), Current Procedural Technology (CPT) codes, Healthcare Common Procedural Coding System codes (HCPCS), and Physician Quality Reporting System (PQRS) codes. Other standard healthcare codes that may be included in patient healthcare data 118 may include Diagnostic Related Group (DRG) codes and National Drug Codes (NDCs). These DRG codes may represent a specific category of disease or health problem the patient suffers from or has suffered from in the past.

Episode module 116 may further determine one or more trigger healthcare service events based on the patient healthcare data 118. For example, information included in patient healthcare data 118 may indicate one or more healthcare service events. Such events may comprise any particular encounter or interaction with the healthcare system, such as admissions to healthcare facilities, outpatient services or procedures, follow up doctor visits, yearly physical exams, and the like. As described above, each of these particular healthcare service events may have one or more standard healthcare codes associated with the events. Trigger healthcare service events may comprise a subset of these healthcare service events. In some examples, which healthcare events, are trigger healthcare service events are predefined. For example, trigger healthcare service events may comprise inpatient admissions, outpatient procedures, and outpatient healthcare services. In other examples, the trigger healthcare service events may more specifically comprise inpatient hospital facility events, outpatient hospital facility events, outpatient emergency room facility events, outpatient surgery facility events, and professional office events. In general, a trigger healthcare service event may be any healthcare service event defined to initiate a patient episode. In examples where service events are identified by standard healthcare codes, episode module 116 may identify the trigger healthcare service events by identifying specific standard healthcare codes that indicate a trigger healthcare service event.

In some examples, some specific healthcare service events may be predefined as trigger healthcare service events. This information of predefined trigger healthcare service events may be stored in episode module data 122. In these examples, episode module 116 may receive information from episode module data 122 indicating the specific healthcare service events that are trigger healthcare service events. Based on this received information, and possibly other received information such as patient healthcare data 118, episode module 116 may then determine the trigger healthcare service events in patient healthcare data 118.

After determining the trigger healthcare service events, episode module 116 may determine specific healthcare service episodes. A healthcare service episode may comprise a specific period of time and include all of the healthcare service events that occur within the specific time period. In some examples, episode module 116 may determine a healthcare service episode based on a trigger healthcare service event. For example, episode module 116 may determine the beginning of a healthcare service episode on the date of occurrence of one of the trigger healthcare service events. In other examples, the healthcare service episode may not begin exactly on the date of the trigger healthcare service event. Rather, the healthcare service episode may comprise a time period surrounding the date of the trigger healthcare service event. For example, a healthcare service episode may comprise a time period including seventy-two hours to a week before the trigger healthcare service event and two months after the healthcare service event.

In some examples, episode module 116 may also define a specific length of time associated with the trigger healthcare service event. For example, episode module 116 may determine the time period length of a healthcare service episode, or episode window length, based on a predefined time period, such as three months. In other examples, the episode window length may vary based on the specific trigger healthcare service event. For example, episode module 116 may determine a first episode window length based on a first trigger healthcare service and may determine a second episode window length, different from the first episode window length, based on a second, different, trigger healthcare service event. In such examples as these, episode module data 122 may store predefined information such as standard episode window lengths, or specific episode window lengths associated with the various trigger healthcare service events. In these examples, episode module 116 may receive the defined episode window lengths or the specific episode window lengths associated with specific trigger healthcare service events from episode module data 122.

In other examples, episode module 116 may determine the episode window length based on received input. For example, user interface module 117, and in conjunction with episode module 116 in some examples, may output a user interface (UI) 132 to output device 130. A user may then enter a specified time period into UI 132. UI module 117 may then communicate the input time period to episode module 116 for use as the determined episode window length. Consequently, episode module 116 may determine a trigger healthcare service event and an episode window length associated with each healthcare service episode. As discussed above, in at least one example the healthcare service episode may begin on the date of the trigger healthcare service event and encompass the time period after the trigger healthcare service event comprising the episode window length. In other examples, the healthcare service episode may comprise a time period surrounding the trigger healthcare service event, but not necessarily beginning on the date of the healthcare service event. In some examples, the episode window length comprises a number of months. In other examples, however, the episode window length may be any unit of time.

Regardless of the time period associated with a particular healthcare service episode, the healthcare service episode includes all of the healthcare service events occurring within the time period encompassed by the healthcare service episode. In this manner, the system and techniques described herein can categorize patient healthcare events into healthcare service episodes with defined time periods rather than trying to determine associations between patient healthcare events and specific diseases. As discussed above, these techniques may reduce the complexity of establishing reimbursement levels for payors or determining expected levels of reimbursement for healthcare professionals and facilities.

In some instances, the time period associated with a particular healthcare service episode may include other trigger healthcare service events not associated with the particular healthcare service episode. In such examples, episode module 116 may shorten the time period associated with a specific healthcare service episode based on occurrences of trigger healthcare service events not associated with the current healthcare service episode. For example, a first healthcare service episode may have an episode window covering the dates between Oct. 1, 2011 and Jan. 1, 2012. In examples where episode module 116 determines a second trigger healthcare service event occurring within that time period, episode module 116 may determine whether to shorten the first episode window length and initiate a second healthcare service episode based on the second trigger healthcare service event. In other examples, episode module 116 may determine not to shorten the initial healthcare service episode and include the second trigger healthcare service event within the initial healthcare service episode. Episode module 116 may determine whether to shorten a healthcare service episode and begin a second healthcare service episode based on predetermined priority rules concerning which trigger healthcare service events take precedence over another trigger healthcare service event. In some examples, these predefined rules are stored in episode module data 122. In such examples, episode module 116 may receive the priority rules from episode module data 122 in the process of determining whether to shorten a current healthcare service episode based on the one or more trigger healthcare priority rules.

In some examples, each trigger healthcare service event may be associated with a hierarchy rank. Episode module 116 may receive these hierarchy ranks and determine whether to shorten a current healthcare service episode based on a second trigger healthcare service event occurring within the time period encompassed by the current healthcare service episode. For example, episode module 116 may compare the hierarchy ranks of the trigger healthcare service event that initiated the current healthcare service episode with the hierarchy rank of the second trigger healthcare service event falling within the episode window associated with the current healthcare service episode. In some examples, these hierarchy rank associations are stored in episode module data 122, and episode module 116 may receive the hierarchy ranks from episode module data 122.

As one illustrative example, an inpatient admission trigger event at a hospital may have a higher hierarchy rank than an outpatient procedure trigger event. In such an example, if the outpatient procedure trigger event occurred within an episode window associated with a healthcare service episode initiated by the inpatient admission trigger event, episode module 116 would not terminate the healthcare service episode based on the outpatient trigger event. Instead, episode module would subsume the outpatient procedure trigger event within the healthcare service episode initiated by the inpatient admission trigger event. In another example, episode module 116 may determine an initial healthcare service episode based on an outpatient procedure trigger event. In this example, a second trigger event with a higher hierarchy rank may occur within the episode window associated with the healthcare service episode initiated by the lower hierarchy ranked outpatient procedure trigger event, such as an inpatient admission trigger event. In this example, episode module 116 may terminate the initial healthcare service episode, i.e. shorten the episode window associated with the initial healthcare service episode, and initiate a second healthcare service episode based on the inpatient admission trigger event.

In some examples the trigger healthcare service events may rank equally in the hierarchy. In such examples, episode module 116 may determine whether to terminate the current healthcare service episode and initiate a new healthcare service episode based on whether the first and second trigger healthcare service events are inpatient trigger events or outpatient trigger events. For example, episode module 116 may determine to terminate a current healthcare service episode associated with an outpatient trigger event and begin a second healthcare service episode based on an inpatient trigger event that falls within the episode window associated with outpatient trigger event. In other examples, episode module 116 may terminate a current healthcare episode based on other information included in patient healthcare data 118. In at least one example, episode module 116 terminates healthcare service episodes if a patient dies within the episode window associated with a healthcare service episode.

As described above, episode module 116 may determine a number of healthcare service episodes based on the patient healthcare data 118. Based on the predetermined priority rules, each healthcare service episode may comprise a distinct, i.e. temporally non-overlapping, time period. During the determination of the various healthcare service episodes for a given patient, episode module 116 may communicate with memory 114 and store the determined healthcare service episodes in healthcare service episodes 120.

The description above focused on determining healthcare service episodes generally based on patient healthcare data 118. However, in some examples, the system and techniques may be applied to specific healthcare data related to one or more patients. In such examples, episode module 116 may determine healthcare service episodes individually for the data associated with each individual patient. Further, based on the trigger healthcare service event priority rules, episode module 116 may determine different healthcare service episodes based on the same or similar trigger healthcare service events for different patients. However, the resulting healthcare service episodes may not necessarily be similar. For example, two sets of patient healthcare data associated with two individual patients may include at least one identical trigger healthcare service event, such as an inpatient admission for a heart attack, for which episode module 116 may initiate healthcare service episodes. Based on subsequent trigger healthcare service events, the determined healthcare service episodes may differ in terms of length and in the healthcare service events included in the two healthcare service episodes. For example, the first patient healthcare data may include a subsequent inpatient admission for heart surgery and the second patient healthcare data may include a subsequent inpatient admission for kidney failure. Based on the predefined trigger healthcare service event priority rules, episode module 116 may shorten the initial determined healthcare service episode in the example of the first patient and determine a second healthcare service episode based on the second trigger healthcare service event. Episode module 116 may further determine not to shorten the initial determined healthcare service episode in the example of the second patient and to subsume the subsequent trigger healthcare service event into the initial determined healthcare service episode.

In other examples, episode module 116 may determine healthcare service episodes for patient healthcare data associated with two individual patients initiated by different trigger healthcare service events, where the patient healthcare data include subsequent similar or identical trigger healthcare service events. As above, episode module 116 may determine the healthcare service episodes for the two patients differently based on the trigger healthcare service event priority rules. For example, episode module 116 may initiate a healthcare service episode associated with the first patient based on a trigger healthcare service event of an inpatient admission for pneumonia. Episode module 116 may further determine to shorten the initial healthcare service episode based on a subsequent trigger healthcare service event comprising an inpatient admission for abdominal pain. Based on patient healthcare data 118 associated with the second patient, episode module 116 may initiate a healthcare service episode based on a trigger healthcare service event of an inpatient admission for abdominal pain. Patient healthcare data 118 associated with the second patient may further include a second, subsequent trigger healthcare service event of an admission for abdominal pain. In the case of the second patient, episode module 116 may not shorten the initial healthcare service episode and may subsume the second trigger healthcare service event into the initial healthcare service episode.

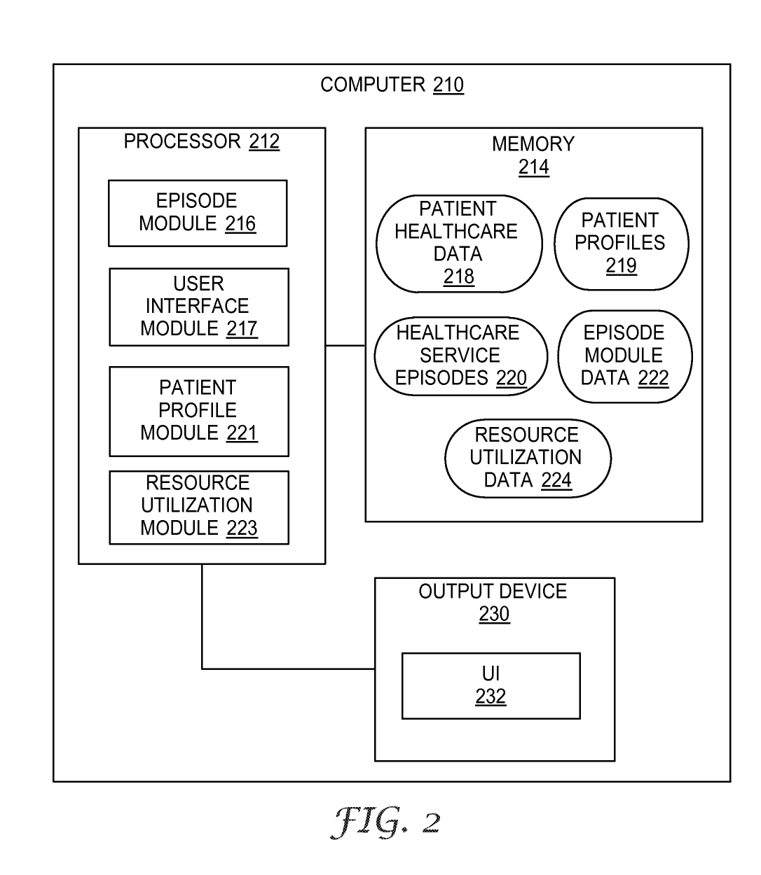

FIG. 2 describes another block diagram illustrating an example of a stand-alone computerized system for determining healthcare service episodes consistent with this disclosure. The system comprises computer 210 that includes a processor 212, a memory 214, and an output device 230. Computer 210 may also include many other components. The illustrated components are shown merely to explain various aspects of this disclosure.

Output device 230 may comprise a display screen, although this disclosure is not necessarily limited in this respect, and other types of output devices may also be used. Memory 214 stores patient healthcare data 218, which may comprise data such as that described with respect to patient healthcare data 118. Memory 214 may further store patient profiles 219, healthcare service episodes 220, episode module data 222, and resource utilization data 224.

Processor 212 is configured to include episode module 216 that executes techniques of this disclosure with respect to patient healthcare data 218, and in some cases, episode module data 222. In some examples, episode module data 222 may comprise information such as which healthcare service events are trigger healthcare service events. In other examples, episode module data 222 may comprise a series of predefined rules identifying trigger healthcare service event priorities, described in further detail below. In still other examples, episode module data 222 may include predefined episode window time periods, also described in further detail below. Processor 212 may be further configured to include a user interface module 217, a patient profile module 221, and a resource utilization module 223.

Processor 212 may comprise a general-purpose microprocessor, a specially designed processor, an application specific integrated circuit (ASIC), a field programmable gate array (FPGA), a collection of discrete logic, or any type of processing device capable of executing the techniques described herein. In one example, memory 214 may store program instructions (e.g., software instructions) that are executed by processor 212 to carry out the techniques described herein. In other examples, the techniques may be executed by specifically programmed circuitry of processor 212. In these or other ways, processor 212 may be configured to execute the techniques described herein. Further, the functionality of the specific modules depicted as included in processor 212 may be combined into fewer, or even a single module, without leaving the scope of this disclosure.

Output device 230 may comprise a display screen, and may also include other types of output capabilities. In some cases, output device 230 may generally represent both a display screen and a printer in some cases. Episode module 216, and communication interface module 217 in some examples, may be configured to cause output device 230 to output patient healthcare data 218, healthcare service episodes 220, or other data. In some instances, output device 230 may include a user interface (UI) 232. UI 232 may comprise an easily readable interface for displaying the output information. Outputting patient healthcare data 218, healthcare service episodes 220, or other data may assist payors in determining patient episodes and further determining or estimating resource utilization associated with patient episodes.

Generally, the similarly-named modules depicted in FIG. 2 may perform similar functions to those similarly-named modules depicted in FIG. 1. For example, episode module 216 may determine healthcare service episodes in a manner similar to that described in relation to episode module 116. However, the modules identified in FIG. 2 may have additional functions.

In some examples, episode module 216 may determine healthcare service episodes based on patient healthcare data 218. In some examples, episode module 216 may determine healthcare service episodes based on patient healthcare data 218 associated with a single patient. In other examples, episode 216 may determine healthcare service episodes based on patient healthcare data 218 associated with a plurality of patients. Further, episode 216 may store these determined healthcare service episodes associated with one or more patients in memory 214 and healthcare service episodes 220.

In some cases, episode module 216 may further process patient healthcare data 218 and/or determined healthcare service episodes. For example, episode module 216 may process the determined healthcare service episodes or patient healthcare data 218 in a similar manner to the process described in U.S. Pat. No. 7,127,407 to Averill et al., the entirety of which is incorporated herein by reference. In one method of further processing, episode module 216 may categorize information included in patient healthcare data 218 or determined healthcare service episodes into a multi-level categorical hierarchy. For example, as described previously, patient healthcare data 218 may include standard healthcare codes, such as ICD codes, CPT codes, HCPCS codes, and the like. Episode module 216 may use these healthcare codes to create and/or place the various healthcare codes into categories such as Major Disease Categories (MDCs) or other categories. Episode module 216 may further assign a severity of illness (SoI) indicator representing a relative severity of illnesses a patient may be, or has been, suffering from. In other examples, the severity of illness indicator indicates the severity level of a trigger healthcare service event. In such examples, a healthcare service episode may further include a SoI indicator, which indicates the severity of the trigger healthcare service event which initiated the healthcare service episode.

Ultimately, episode module 216 may assign a determined healthcare service episode to a Clinical Risk Group (CRG) based on the determined categories. In some examples, episode module 116 may further determine a single adjustment factor based on the CRG assignment and the SoI indicator. This adjustment value may indicate a relative risk level. For example, the adjustment value may indicate that a specific healthcare service episode represents a relatively more complex episode than other, similar healthcare service episodes. As further described below, this adjustment value may further indicate that a specific healthcare service episode may use relatively more or less resources than other, similar healthcare service episodes.

In some examples, episode module 216 may determine a CRG window. The CRG window may define a period of time surrounding a particular healthcare service episode. In some examples, the CRG window may comprise a period of time before a healthcare service event. In other examples, the CRG window may comprise a period of time after a healthcare service event. In still other examples, the CRG window may comprise a period of time that encompasses a healthcare service event and may further extend prior to and/or subsequent to the healthcare service event. In some examples, each trigger healthcare service event may be associated with a specific CRG window. In other examples, episode module 216 may receive a predetermined CRG window from episode module data 222. In still other examples, episode module 216 may determine a CRG window based on received user input. Episode module 216 may further determine the CRG assignment and SoI indicator based on any patient healthcare data 218, for example, healthcare service events, falling within the CRG window.

Patient profile module 221 may determine a patient profile consisting of a sequence of temporally non-overlapping healthcare service episodes associated with a single patient. In some examples, patient profile module 221 may receive determined healthcare service episodes from healthcare service episodes 220. After determining a one or more patient profiles based on the determined healthcare service episodes stored in healthcare service episodes 220, patient profile module 221 may then store the determined patient profiles in memory 214 and patient profiles 219. In this manner, the described system and techniques may create a plurality of patient profiles consisting of individual, temporally non-overlapping healthcare service episodes. Such a database may assist payors in setting or estimating resource utilization for specific healthcare service episodes and in allowing payors to compare patients with similar healthcare service episodes in a less complex manner than by traditional means.

Processor 212 may further include a resource utilization module 223. Resource utilization module 223 may determine a total level of resource utilization based on the determined patient healthcare service episodes. In some examples, resource utilization module 223 may receive information from patient healthcare data 218 and healthcare service episodes 220. For example, resource utilization module 223 may receive a single healthcare service episode from healthcare service episodes 220. This healthcare service episode may include a number of healthcare service events. In some examples, the healthcare service episode further includes associated CRG assignment and SoI indicator. In addition to including the information described with respect to patient healthcare data 118, patient healthcare data 218 may also include resource utilization data. Resource utilization data may include financial metrics such as charge amounts or reimbursement amounts associated with the healthcare service events included in patient healthcare data 218. As one illustrative example, patient healthcare data 218 may include information relating to a healthcare service event comprising a yearly physical exam. In some examples, the included information may comprise information about any charges issued by the healthcare professional and facility involved in administering the physical exam and any reimbursement amounts provided by one or more payors. In still other examples, these charge amounts and reimbursement amounts may be determined based on the specific standard healthcare codes included in patient healthcare data 218. In at least one example, resource utilization module 223 may determine a resource utilization value for each determined healthcare service episode based on any such patient healthcare data 218 and healthcare service events falling within each determined healthcare service episode. For example, a resource utilization value may comprise the totality of the charges issued by healthcare professionals and facilities for treating a patient. In other examples, a resource utilization value may comprise the totality of reimbursement paid to healthcare professionals and facilities for treatment of a patient. In other examples, a resource utilization value may comprise other metrics of resource utilization associated with treating a patient in a healthcare setting.

In some examples, episode module 216 and resource utilization module 223 may determine healthcare service episodes and resource utilization values for determined healthcare service episodes based on patient healthcare data 218 and on received selection input from a user. For example, user interface module 217, and in conjunction with episode module 216 in some examples, may output a user interface (UI) 232 to output device 230. A user, viewing UI 232, may enter selection input comprising one or more parameters. User interface module 217 may then communicate the parameters to episode module 216. In this manner, a user may enter one or more parameters to configure episode module 216 in determining the healthcare service episodes and resource utilization module 223 in determining resource utilization values.

In some examples, the parameters may comprise a specific healthcare service episode. In other examples, the parameters may comprise a specific trigger healthcare service event as opposed to a specific healthcare service episode. In at least one example, the parameters may further define a specific time period. In still other examples, the parameters may further comprise patient characteristic data. In some examples, patient characteristic data may include demographic parameters such as age, gender, race, height, weight, and other demographic information. Patient characteristic data may further include information about disease burden. In at least one example, patient characteristic data may comprise one or more disease or other health problem parameters. These particular parameters may limit the scope of episode module 216 in determining healthcare service episodes and resource utilization module 223 in determining resource utilization values.

Episode module 216 may determine healthcare service episodes based on these received parameters and on received patient healthcare data 218. For example, episode module 216 may receive patient healthcare data and determine healthcare service episodes based on the received selected trigger healthcare service event. In other examples, episode module 216 may determine healthcare service episodes based on trigger healthcare service events, or one or more received trigger healthcare service events, occurring between a received time period selection. In still other examples, episode module 216 may determine healthcare service episodes using patient healthcare data 218 which satisfies the received patient characteristic data selections. In this manner, by entering the various selection parameters, a user may configure episode module 216 in determining healthcare service episodes. This configurability may assist a user, such as a payor in establishing reimbursement rates, such as for payors.

Another parameter may comprise an episode window length parameter. In these examples, a user may input a number of days or months describing the length of the episode window. Accordingly, episode module 216, in determining healthcare service episodes, may determine that the episode window length associated with each healthcare service episode comprises the episode window length parameter. For example, a user may enter an episode window length parameter of three months. In determining the healthcare service episodes, episode module 216 may then determine that each healthcare service episode comprises a time period of three months, and only include healthcare service events which fall within a time period comprising the received episode window length in the determined healthcare service episodes.

In some examples, one or more parameters may comprise one or more CRG status parameters. In some examples, these CRG status parameters include a CRG window parameter. In at least one example, the CRG status parameter or parameters include a SoI indicator. The CRG window parameter may define a specific length of time and may further include an indication specifying whether the CRG window is prior to, subsequent to, or fully or partially coincident with the healthcare service episodes. Episode module 216 may use this CRG window parameter in further processing the determined healthcare service episodes. As one example, the CRG window length may be three months and specify the time period is prior to the determined trigger healthcare service events. In such an example, episode module 216 may take into consideration only those healthcare service events falling within the three months prior to a determined trigger healthcare service event when processing a healthcare service episode to determine a CRG assignment and SoI indicator associated with the selected healthcare service episode or trigger healthcare service event. As described previously, the determined CRG assignment and SoI indicator may be further combined into a single adjustment factor.

In some examples the parameters may comprise resource type parameters. Resource type parameters may comprise which categories of resources resource utilization module 223 may include in estimating a resource utilization value. For example, resource type parameters may comprise categories such as an Inpatient Hospital Facility category, a Hospice Facility category, a Skilled Nursing Facility category, an Extended Care Facility category, an Outpatient Hospital Facility category, an Outpatient ER Facility category, an Outpatient a Surgery Facility category, a Home Health category, a Professional Ancillary category, a Professional Inpatient category, a Professional Outpatient category, a Professional Extended Care category, a Professional Office category, a Retail Pharmacy category, an Outpatient/Professional Pharmacy category, an Outpatient/Professional DME category, an Outpatient/Professional Laboratory category, an Outpatient/Professional Diagnostic Radiology category, and a Miscellaneous Facility category. As described previously, patient healthcare data 218 may comprise information regarding financial metrics such as charge amounts or reimbursement amounts. Patient healthcare data 218 may further include information separating those charge or reimbursement amounts into separate categories. In some examples, those separate categories may correspond to the resource type selection parameters. In examples where patient healthcare data 218 includes standard healthcare codes, those healthcare codes may specify, explicitly or implicitly, to which resource type categories the specific charges or reimbursement amounts belong. In this manner, resource utilization module 223 may determine which charge or reimbursement amounts are included in the resource utilization value determination.

Based on these received resource type parameters, resource utilization module 223 may determine resource utilization values for all of the determined healthcare service episodes based on the other received parameters, for example the received trigger healthcare service event, a determined healthcare service episode, or the like. Furthermore, resource utilization module 223 may categorize the determined resource utilization values based on the CRG assignment, SoI indicator, and/or risk adjustment factor associated with each of the determined healthcare service events. In this way, the system and techniques may assist a payor in determining resource utilization values for not only specific healthcare service episodes, but also for healthcare service episodes based on CRG assignments, SoI indicators, and/or risk adjustment factors. Categorizing the healthcare service events into such healthcare service episodes and determining resource utilization values may assist payors in establishing reimbursement amounts in a less complex manner than determining reimbursement amounts based on specific diagnosed diseases or health problems.

In one example, resource utilization module 223 may estimate resource utilization values for specific healthcare service episodes. For example, resource utilization module 223 may determine resource utilization values for all of the determined healthcare service episodes based on received parameters. Resource utilization module 223 may also determine an average resource utilization value. As described previously with respect to determining resource values, resource utilization module 223 may categorize the determined resource utilization values based on CRG assignments, SoI indicators, and/or risk adjustment factors. Based on these determined values, resource utilization module 223 may further determine an average resource utilization value for the determined healthcare service episodes. This average resource utilization value may be an estimate of future resource utilization for healthcare service episodes conforming to the received selection parameters. Further, resource utilization module 223 may determine adjustments to the estimates based on determined CRG assignments, SoI indicators, and/or risk adjustment factors associated with the determined healthcare service episodes. For instance, a high risk adjustment factor may indicate that a particular healthcare service episode may require more resources than the determined average similar healthcare episode. Resource utilization module 223 may adjust the estimate to comprise a higher resource utilization value for the specific healthcare service episode associated with a higher adjustment factor.

In some examples, the adjustment factor may be a function of a plurality of parameters, for example, CRG status parameters, resource type parameters, patient characteristic data, trigger healthcare service event or healthcare service event parameters, or other described parameters. As described above, resource utilization module 223 may determine resource utilization values associated with healthcare service episodes based on all of the entered selection input and an average resource utilization value based on the determined resource utilization values. Resource utilization module 223 may further determine an adjustment factor for each healthcare service episode. For example, for each healthcare service episode identified by the entered selection parameters, resource utilization module 223 may divide the determined resource utilization value associated with each healthcare service episode by the average resource utilization value. The resulting unit-less parameter may be the adjustment factor. In this manner, resource utilization module 223 may determine an adjustment factor signifying how much more or less resources a particular healthcare service episode required as compared to other similar healthcare service episodes.

Resource utilization module 223 may also communicate the determined resource utilization values to memory 214 and store the determined values at resource utilization data 224. Also in some examples, resource utilization module 223 may output the determined values to UI 232 for display at output device 230.

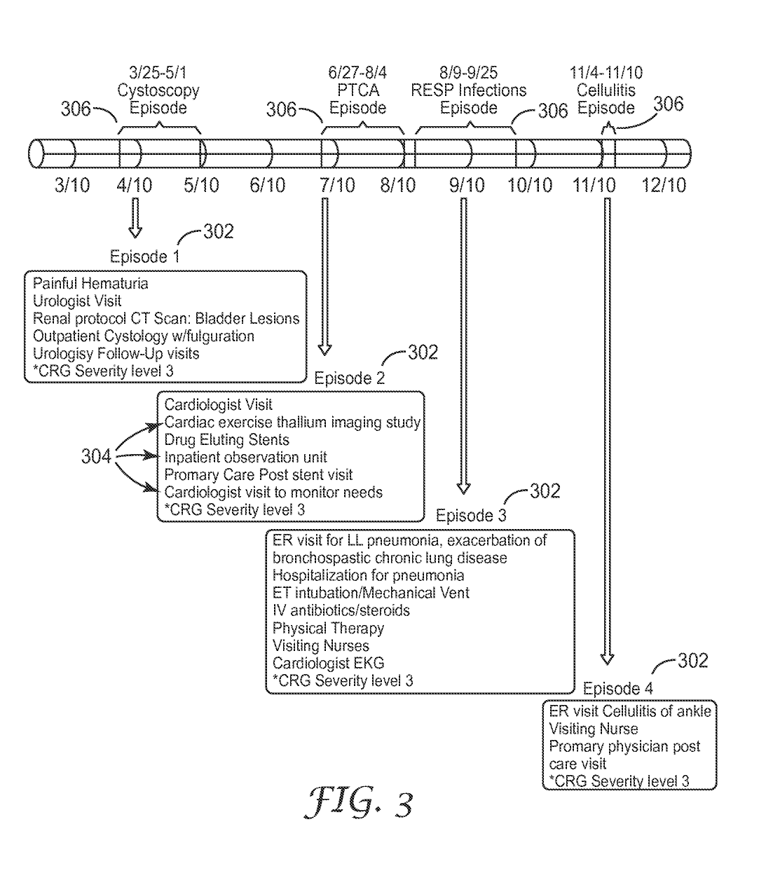

FIG. 3 is a conceptual diagram illustrating a plurality of healthcare service events for a single patient broken down in healthcare service episodes, i.e. a patient profile. The depicted healthcare service episodes 302 (described as Episode 1, Episode 2, Episode 3, and Episode 4 in FIG. 3) may be similar to the healthcare service episodes produced by, for example, episode module 116 or episode module 216. As depicted, each of the healthcare episodes 302 include one or more individual healthcare events 304. Further each of the healthcare service episodes 302 comprise a temporally non-overlapping time period 306. For example, Episode 1 is depicted as spanning the time period from 3/25 to 5/1 and includes healthcare service events Painful Hernia, Urologist Visit, Renal CT Scan: Bladder Lesions, Outpatient Cytoscopy w/fulguration, and Urologist Follow-Up visits. Also depicted in each healthcare service episode 302 is a SoI indicator. As described previously, healthcare service episodes may include such indicators, and the indicators may assist resource utilization module 223 in determining or estimating resource utilization values.

The system of FIG. 1 is a stand-alone system in which processor 112 that executed episode module 116 and output device 130 that outputs various data and receives one or more input parameters reside on the same computer 110. However, the techniques of this disclosure may also be performed in a distributed system that includes a server computer and a client computer. In this case, the client computer may communicate with the server computer via a network. The coding module may reside on the server computer, but the output device may reside on the client computer. In this case, when the coding module causes display prompts, the coding module causes the output device of the client computer to display the prompts, e.g., via commands or instructions communicated based on the server computer to the client computer.

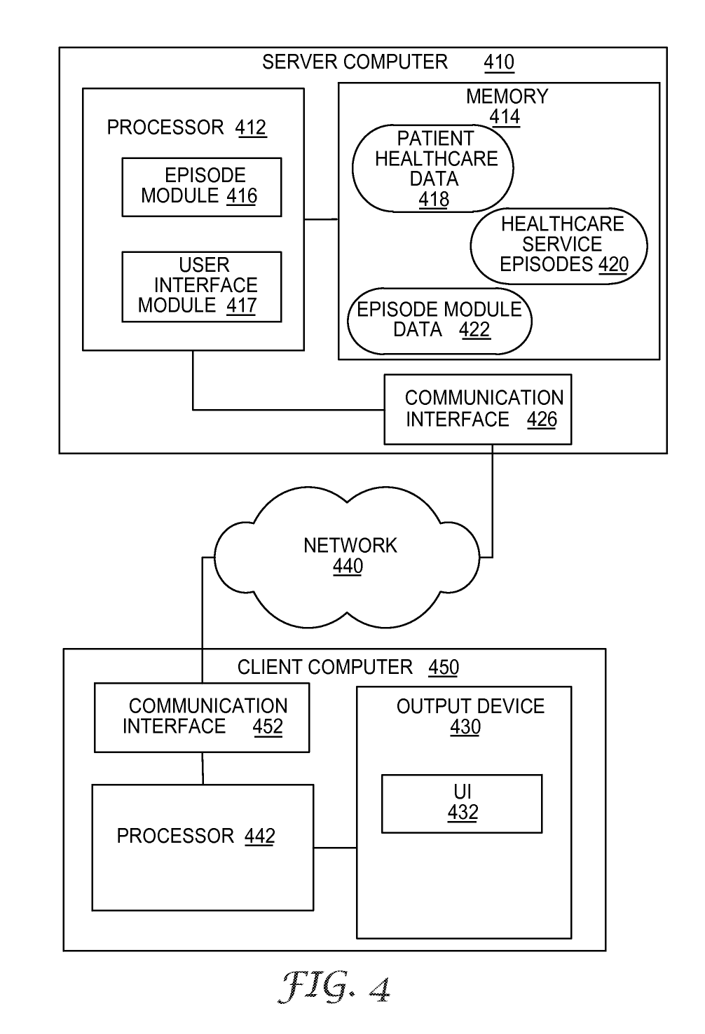

FIG. 4 is a block diagram of a distributed system that includes a server computer 410 and a client computer 450 that communicate via a network 440. In the example of FIG. 4, network 440 may comprise a proprietary on non-proprietary network for packet-based communication. In one example, network 440 comprises the Internet, in which case communication interfaces 426 and 452 may comprise interfaces for communicating data according to transmission control protocol/internet protocol (TCP/IP), user datagram protocol (UDP), or the like. More generally, however, network 440 may comprise any type of communication network, and may support wired communication, wireless communication, fiber optic communication, satellite communication, or any type of techniques for transferring data between a source (e.g., server computer 410) and a destination (e.g., client computer 440).

Server computer 410 may perform the techniques of this disclosure, but the user may interact with the system via client computer 450. Server computer 410 may include a processor 412, a memory 414, and a communication interface 426. Client computer 450 may include a communication interface 452, a processor 442 and an output device 430. Of course, client computer 450 and server computer 410 may include many other components. The illustrated components are shown merely to explain various aspects of this disclosure.

Output device 430 may comprise a display screen, although this disclosure is not necessarily limited in this respect and other output devices may also be used. Memory 414 stores patient healthcare data 418, which may comprise data collected in documents such as patient healthcare records, among other information. Memory 414 further stores healthcare service episodes 420 and episode module data 422. Processor 412 of server computer 410 is configured to include episode module 416 that executes techniques of this disclosure with respect to patient healthcare data 418.

Processors 412 and 442 may each comprise a general-purpose microprocessor, a specially designed processor, an application specific integrated circuit (ASIC), a field programmable gate array (FPGA), a collection of discrete logic, or any type of processing device capable of executing the techniques described herein. In one example, memory 414 may store program instructions (e.g., software instructions) that are executed by processor 412 to carry out the techniques described herein. In other examples, the techniques may be executed by specifically programmed circuitry of processor 412. In these or other ways, processor 412 may be configured to execute the techniques described herein.

Output device 430 on client computer 450 may comprise a display screen, and may also include other types of output capabilities. For example, output device 430 may generally represent both a display screen and a printer in some cases. Episode module 416 may be configured to cause output device 430 of client computer 450 to output patient healthcare data 418 or healthcare service episodes 420. User interface 432 may be generated, e.g., as output on a display screen, so as to allow a user enter various selection parameters or other information.

Similar to the stand alone example of FIGS. 1-2, in the distributed example of FIG. 4, episode module 416 may determine healthcare services episodes based on patient healthcare data 418. Episode module 416 may further determine resource utilization values. In some examples, determining the resource utilization values is based at least in part on received selection parameters. Episode module 416 may receive such selection parameters from client computer 450. For example, a user may enter the selection parameters at user interface (UI) 432. Again, communication interfaces 426 and 452 allow for communication between server computer 410 and client computer 450 via network 440. In this way, episode module 416 may execute on server computer 410 but may receive input from client computer 450. A user operating on client computer 450 may log-on or otherwise access episode module 416 of server computer 410, such as via a web-interface operating on the Internet or a propriety network, or via a direct or dial-up connection between client computer 450 and server computer 410. In some cases, data displayed on output device 430 may be arranged in web pages served from server computer 410 to client computer 450 via hypertext transfer protocol (HTTP), extended markup language (XML), or the like.

In at least one example, episode module 416 receives patient healthcare data 418. Patient healthcare data 418 may include information included in a patient healthcare record or any other documents or files describing a patient encounter with a healthcare facility. For example, when a patient has an encounter with a healthcare facility, such as during an inpatient admission or an outpatient visit, all of the information gathered during the encounter may be consolidated into a patient healthcare record. In one example, such a patient healthcare record may include any procedures performed, any medications prescribed, any notes written by a physician or nurse, and generally any other information concerning the patient encounter with the healthcare facility. Further, patient healthcare data 418 may also include information from healthcare claims forms. Each piece of information included in patient data 418 may further be associated with a particular date. For example, patient healthcare data 418 may include multiple pieces of information associated with an inpatient admission event occurring on Mar. 20^{th}, 2005. In such an example, each piece of information related to that inpatient admission event may further be associated with the date Mar. 20^{th}, 2005 (or other relevant date if all the services or procedures relating to the inpatient admission did not occur on that exact date).

Patient healthcare data 418 may further include one or more standard healthcare codes. In some examples, the patient healthcare records or the healthcare claims forms may include one or more of these standard healthcare codes, which generally may describe the services and procedures delivered to a patient. Examples of such healthcare codes include codes associated with the International Classification of Diseases (ICD) codes (versions 9 and 10), Current Procedural Technology (CPT) codes, Healthcare Common Procedural Coding System codes (HCPCS), and Physician Quality Reporting System (PQRS) codes. Other standard healthcare codes that may be included in patient healthcare data 118 may be Diagnostic Related Group (DRG) codes and National Drug Codes (NDCs). These DRG codes may represent a specific category of disease or health problem the patient suffers from or has suffered from in the past.

Episode module 416 may further determine one or more trigger healthcare service events based on the patient healthcare data 418. For example, information included in patient healthcare data 418 may indicate one or more healthcare service events. Such events may comprise any particular encounter or interaction with the healthcare system, such as admissions to healthcare facilities, outpatient services or procedures, follow up doctor visits, yearly physical exams, and the like. As described above, each of these particular healthcare service events may have one or more standard healthcare codes associated with the events. Trigger healthcare service events may comprise a subset of these healthcare service events. For example, trigger healthcare service events may comprise inpatient admissions, outpatient procedures, and outpatient healthcare services. In other examples, the trigger healthcare service events may more specifically comprise inpatient hospital facility events, outpatient hospital facility events, outpatient emergency room facility events, outpatient surgery facility events, and professional office events. In general, a trigger healthcare service event may be any healthcare service event defined to initiate a patient episode.

In some examples, which healthcare service events comprise trigger healthcare service events may be predefined. This information may further be stored in episode module data 422. In these examples, episode module 416 may receive information from episode module data 422 indicating which healthcare service events comprise trigger healthcare service events. Based on this received information, and further based on other received information such as patient healthcare data 418, episode module 416 may then determine the trigger healthcare service events included in patient healthcare data 418.

After determining the trigger healthcare service events, episode module 416 may determine specific healthcare service episodes. A healthcare service episode may define a specific period of time and include all of the healthcare service events that occur within the specified time period. In some examples, episode module 416 may determine a healthcare service episode based on a trigger healthcare service event. For example, episode module 416 may determine the beginning of a healthcare service episode on the date of occurrence of one of the trigger healthcare service events. In other examples, the healthcare service episode may not begin exactly on the date of the trigger healthcare service event. Rather, the healthcare service episode may comprise a time period surrounding the date of the trigger healthcare service event. For example, a healthcare service episode may comprise a time period including one month before the trigger healthcare service event and two months after the healthcare service event.

In some examples, episode module 416 may also define a specific length of time associated with a trigger healthcare service event. For example, episode module 416 may determine a length of time associated with a healthcare service episode, or episode window length, based on a predefined time period, such as three months. In other examples, the episode window length may vary based on the specific trigger healthcare service event. For example, episode module 416 may determine a first episode window length based on a first trigger healthcare service and may determine a second episode window length, different from the first episode window length, based on a second, different, trigger healthcare service event. In such examples as these, episode module data 422 may store predefined information such as standard episode window lengths, or specific episode window lengths associated with the various trigger healthcare service events. In these examples, episode module 416 may receive the defined episode window lengths or the specific episode window lengths associated with specific trigger healthcare service events from episode module data 422.

In still other examples, episode module 416 may determine the episode window length based on received input. For example, user interface module 417 may output a user interface (UI) 432 to output device 430. A user may then enter a time period into UI 432. UI module 417 may then communicate the input timer period to episode module 416 for use as the episode window length. Consequently, episode module 416 may determine a trigger healthcare service event and an episode window length associated with each healthcare service episode. As discussed previously with respect to FIGS. 1-2, in at least one example the healthcare service episode may begin on the date of the trigger healthcare service event and encompass the time period after the trigger healthcare service episode within the episode window length. In other examples, the healthcare service episode may comprise a time period surrounding the trigger healthcare service event, but not necessarily beginning on the date of the healthcare service event. In some examples, the episode window length comprises a number of months. In other examples, however, the episode window length may be any unit of time.

Regardless of the time period associated with a particular healthcare service episode, the healthcare service episode includes all of the healthcare service events occurring within the time period encompassed by the healthcare service episode. In this manner, the system and techniques described herein categorize patient healthcare events into healthcare service episodes with defined time periods rather than trying to determine associations between patient healthcare events and specific diseases. As discussed above, these techniques may reduce the complexity of setting reimbursement levels for payors or determining expected levels of reimbursement for healthcare professionals and facilities.

In some instances, time period associated with a particular healthcare service episode may include other trigger healthcare service events not associated with the particular healthcare service episode. In such examples, episode module 416 may shorten the time period associated with a current healthcare service episode based on occurrences of trigger healthcare service events not associated with the current healthcare service episode. For example, a first healthcare service episode may have an episode window covering the dates between Oct. 1, 2011 and Jan. 1, 2012. In examples where episode module 416 determines a second trigger healthcare service event occurring within that time period, episode module 416 may determine whether to shorten the first episode window length and initiate a second healthcare service episode based on the second trigger healthcare service event. In other examples, episode module 416 may determine not to shorten the initial healthcare service episode and include the second trigger healthcare service event within the initial healthcare service episode. Episode module 416 may determine whether to shorten a healthcare service episode and begin a second healthcare service episode based on predetermined priority rules concerning which trigger healthcare service events take precedence in beginning a new healthcare service episode or being subsumed within another healthcare service episode. In some examples, these predefined rules are stored in episode module data 422. In such examples, episode module 416 may receive the priority rules from episode module data 422 in the process of determining whether to shorten a current healthcare service episode based on the one or more trigger healthcare priority rules.

As described above, episode module 416 may determine a number of healthcare service episodes based on the patient healthcare data 418. Based on the predetermined priority rules, each healthcare service episode will comprise a distinct, i.e. temporally non-overlapping, time period. During the determination of the various healthcare service episodes for a given patient, episode module 416 may communicate with memory 414 and store the determined healthcare service episodes in healthcare service episodes 420.

Although described with separate modules in FIG. 2, episode module 416 may further perform the additional functions of determining patient profiles, determining resource utilization values, and estimating resource utilization values.

For example, after determining healthcare service episodes based on patient healthcare data 418, episode module 416 may further process patient healthcare data 418 and/or determined healthcare service episodes. In some examples, episode module 416 may further process the determined healthcare service episodes or patient healthcare data 418 in a similar manner to the process described earlier and in incorporated reference U.S. Pat. No. 7,127,407. As one illustrative example, episode module 416 may further associate a CRG assignment and a severity of illness (SoI) indicator with each determined healthcare service episode. Episode module 416 may also determine a risk adjustment factor based on the associated CRG assignment and SoI indicator for each healthcare service episode.

Episode module 416 may also determine one or more patient profile consisting of a sequence of temporally non-overlapping healthcare service episodes associated with a single patient. In some examples, episode module 416 may receive determined healthcare service episodes from healthcare service episodes 420. After determining a one or more patient profiles based on the determined healthcare service episodes stored in healthcare service episodes 420, episode module 416 may then store the determined patient profiles in memory 414.

Episode module 416 may further determine a total level of resource utilization based on the determined patient healthcare service episodes. In some examples, episode module 416 may receive information from patient healthcare data 418 and healthcare service episodes 420. For example, episode module 416 may receive a single healthcare service episode from healthcare service episodes 420. This healthcare service episode may include a number of healthcare service events. In addition to including the information described with respect to patient healthcare data 118, patient healthcare data 418 may also include any financial metrics such as charge amounts or reimbursement amounts associated with the healthcare service events included in patient healthcare data 418. In still other examples, these charge amounts and reimbursement amounts may be indicated by the specific standard healthcare codes included in patient healthcare data 418. In at least one example, episode module 416 may determine a resource utilization value for each determined healthcare service episode.

In some examples, episode module 416 may determine resource utilization values for determined healthcare service episodes based on received selection parameters from a user. For example, user interface module 417 may output a user interface (UI) 432 to output device 430. A user, viewing UI 432, may enter selection parameters. User interface module 417 may then communicate the selection parameters to episode module 416.

In some examples, the selection parameters comprise a specific healthcare service episode. In other examples, the selection parameter may comprise a specific trigger healthcare service event as opposed to a specific healthcare service episode. These particular selection parameters may limit the scope of the resource utilization determination. For example, episode module 416 may only determine a resource utilization value for the specific selected healthcare episodes or the healthcare episodes associated with the selected trigger healthcare service event. Another selection parameter may comprise an episode window length parameter. In these examples, a user may input a number of hours, days, or months describing the length of the episode window. This parameter may differ from the episode window length associated with the determined healthcare service episodes. Accordingly, only the healthcare service events which fall within the received episode window length will be included in the resource utilization determination.

In some examples the selection parameters may comprise resource types. Resource type selection parameters may comprise which types of resources episode module 416 may include in estimating a resource utilization value. For example, resource type selection parameters may comprise categories such as an Inpatient Hospital Facility category, a Hospice Facility category, a Skilled Nursing Facility category, an Extended Care Facility category, an Outpatient Hospital Facility category, an Outpatient ER Facility category, an Outpatient a Surgery Facility category, a Home Health category, a Professional Ancillary category, a Professional Inpatient category, a Professional Outpatient category, a Professional Extended Care category, a Professional Office category, a Retail Pharmacy category, an Outpatient/Professional Pharmacy category, an Outpatient/Professional DME category, an Outpatient/Professional Laboratory category, an Outpatient/Professional Diagnostic Radiology category, and a Miscellaneous Facility category. As described previously with respect to FIGS. 1-2, patient healthcare data 418 may comprise resource utilization data such as financial metrics regarding charge amounts or reimbursement amounts. Patient healthcare data 418 may further include information separating those charge or reimbursement amounts into separate categories. In some examples, those separate categories may correspond to the resource type parameters. In examples where patient healthcare data 418 includes standard healthcare codes, those healthcare codes may specify, explicitly or implicitly, to which resource type categories the specific charges or reimbursement amounts belong. In this manner, episode module 416 may determine which charge or reimbursement amounts are included in the resource utilization value determination.

In some examples, the selection parameter may comprise one or more CRG status parameters. In some examples, these CRG status parameters include a CRG window length parameter. In these examples, the CRG window length parameter may be a specified time period surrounding the entered specific healthcare service episode or trigger healthcare service event. Episode module 416 may use this CRG window parameter in further processing the healthcare service episode. As described above, episode module 416 may further process the healthcare service episodes based on a method similar to the one described in the incorporated reference U.S. Pat. No. 7,127,407 to Averill et al. For example, episode module 416 may take into consideration only those healthcare service events falling within the CRG window parameter when processing the healthcare service episode to determine CRG assignments and SoI indicators associated with the selected healthcare service episodes or trigger healthcare service events. As described previously, the determined CRG assignment and SoI indicator may be further combined into a single adjustment factor.

Based on all of these received selection parameters, episode module 416 may determine resource utilization values for all of the healthcare service episodes corresponding to the received healthcare service episode or trigger healthcare service event parameter. Further, episode module 416 may categorize the determined resource utilization values based on the CRG assignment, severity level indicator, and/or risk adjustment factor associated with each of the determined healthcare service events. In this way, the system and techniques may assist a payor in determining resource utilization values for not only specific healthcare service episodes, but also for healthcare services episodes based on CRG assignments, SoI indicators, and/or risk adjustment factors. Categorizing the healthcare service events into such healthcare service episodes and determining these resource utilization values may assist payors in establishing reimbursement amounts in a less complex manner determining reimbursement amounts based on specific diagnosed diseases or health problems.

In one example, episode module 416 may further estimate resource utilization values for specific healthcare service episodes. For example, episode module 416 may determine resource utilization values for all of the selected healthcare service episodes and determine an average resource utilization value. As described previously, episode module 416 may categorize the determined resource utilization values based on CRG assignments, severity level indicators, and/or risk adjustment factors. Based on these determined values, episode module 416 may further determine an average resource utilization value for the specific healthcare service episode. This average resource utilization value may be an estimate of future resource utilization for those specific healthcare service episodes. Further, episode module 416 may determine adjustments to the estimate based on determined CRG assignment, severity indicator, and/or risk adjustment factor for the specific healthcare service episode. For instance, a high risk adjustment factor may indicate that a particular episode may utilize more resources than the determined average similar healthcare episode. Therefore, episode module 416 may estimate a higher resource utilization value for the specific healthcare service episode.

In some examples, the adjustment factor may be a function of a plurality of parameters, for example, CRG status parameters, resource type parameters, patient characteristic data, trigger healthcare service event or healthcare service event parameters, or other described parameters. As described above, resource utilization module 423 may determine resource utilization values associated with healthcare service episodes based on all of the entered selection input and an average resource utilization value based on the determined resource utilization values. Resource utilization module 423 may further determine an adjustment factor for each healthcare service episode. For example, for each healthcare service episode identified by the entered selection parameters, resource utilization module 423 may divide the determined resource utilization value associated with each healthcare service episode by the average resource utilization value. The resulting unit-less parameter may be the adjustment factor. In this manner, resource utilization module 423 may determine an adjustment factor signifying how much more or less resources a particular healthcare service episode required as compared to other similar healthcare service episodes.

In at least of the above described examples, episode module 416 may further communicate the determined resource utilization values to and store the values in memory 414. Also in some examples, episode module 416 may output the determined values to UI 432 for display at output device 430.

In some examples, instead of determining a resource utilization value based on a specific healthcare service episode, episode module 416 may determine a resource utilization value over a specific time period.

In such examples, a user may further input a time period parameter instead of a healthcare service episode or trigger healthcare service event parameter. In some examples, a user may further enter one or more group identification parameters at UI 432 at client computer 450. As described previously, client computer 450 may communicate the input through communication interface 452 to communication interface 426. Subsequently, communication interface 426 may communicate the input to episode module 416. These group identification selection parameters may include demographic parameters and/or disease parameters.

Based on these received parameters, episode module 416 may identify specific patient healthcare data 418 or patent profiles corresponding to the received parameters to include in a resource utilization determination. Episode module 416 may then identify the specified time period within each identified patient profile or patient profile data 418 associated with specific patients and identify all the healthcare service events that fall within those time periods. Similarly to determining a resource utilization value with respect to a specific healthcare episode, episode module 416 may then determine a resource utilization value based on all of the identified healthcare service events falling within the specific parameters.

Similarly to determining a resource utilization parameter based on specific episodes, episode module 416 may further categorize the determined resource parameter based on CRG assignments and severity level indicators and/or risk adjustment factors associated with the particular patient profiles and the healthcare service events and episodes falling within the specified parameters.

Also as discussed previously with respect to determining resource utilization values based around specific healthcare service episodes, episode module 416 may further estimate resource utilization values based on received parameters such as demographic information and/or disease information. For example, episode module 416 may determine all the resource utilization values associated with individual patient profiles based on the received selection parameters. Episode module 416 may then determine an average resource utilization value based on all the determined resource utilization values. This average resource utilization value may be an estimate of future resource utilization values for patients with similar demographic qualities and patient profiles as those included in the estimation.

In this manner, the system and techniques provide a way for a payor or other entity to easily determine the resource utilization values for specific groups of patients over specified time periods. This determination may be less complex than current methods which may try to estimate resource utilization by ascribing specific healthcare events to individual diseases.

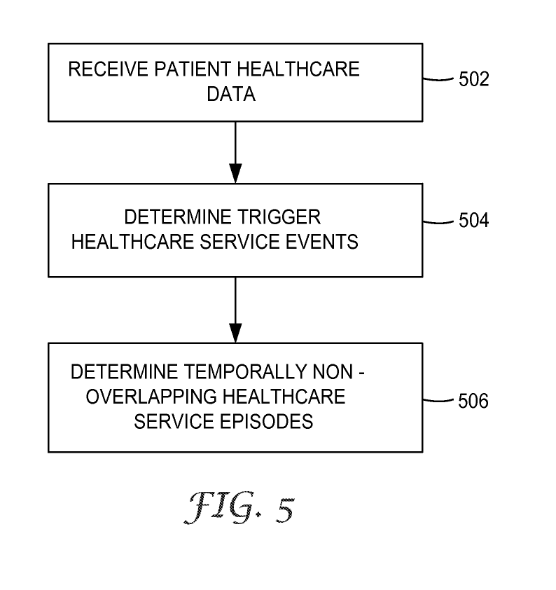

FIGS. 5-8 are flow diagrams illustrating techniques consistent with this disclosure. FIGS. 5-8 will be described from the perspective of computer 110 of FIG. 1, although the system of FIG. 2, or FIG. 4, or other systems could also be used to perform such techniques. As shown in FIG. 5, episode module 116 receives patient healthcare data 118 (502). Patient healthcare data 118 may include information included in a patient healthcare record or any other documents or files describing a patient encounter with a healthcare facility. For example, when a patient has an encounter with a healthcare facility, such as during an inpatient admission or an outpatient visit, all of the information gathered during the encounter may be consolidated into a patient healthcare record. In one example, such a patient healthcare record may include any procedures performed, any medications prescribed, any notes written by a physician or nurse, and generally any other information concerning the patient encounter with the healthcare facility. Further, patient healthcare data 118 may also include information from healthcare claims forms. Each piece of information included in patient data 118 may further be associated with a particular date. For example, patient healthcare data 118 may include multiple pieces of information associated with an inpatient admission event occurring on Mar. 20^{th}, 2005. In such an example, each piece of information related to that inpatient admission event may further be associated with the date Mar. 20^{th}, 2005 (or other relevant date if all the services or procedures relating to the inpatient admission did not occur on that exact date).

In some examples, Patient healthcare data 118 may further include one or more standard healthcare codes. In some examples, the patient healthcare records or the healthcare claims forms may include one or more of these standard healthcare codes, which generally may describe the services and procedures delivered to a patient. Examples of such healthcare codes include codes associated with the International Classification of Diseases (ICD) codes (versions 9 and 10), Current Procedural Technology (CPT) codes, Healthcare Common Procedural Coding System codes (HCPCS), and Physician Quality Reporting System (PQRS) codes. Other standard healthcare codes that may be included in patient healthcare data 118 may be Diagnostic Related Group (DRG) codes and National Drug Codes (NDCs). These DRG codes may represent a specific category of disease or health problem the patient suffers from or has suffered from in the past.

Episode module 116 also determines trigger healthcare service events (504). As described previously with respect to FIG. 1, trigger healthcare service events may comprise a subset of general healthcare service events, which may be defined by patient encounters with the healthcare system or even by standard healthcare codes. In some examples, trigger healthcare service events may comprise inpatient admissions, outpatient procedures, and outpatient healthcare services. In other examples, the trigger healthcare service events may more specifically comprise inpatient hospital facility events, outpatient hospital facility events, outpatient emergency room facility events, outpatient surgery facility events, and professional office events. In general, a trigger healthcare service event may be any healthcare service event defined to initiate a patient episode.

Episode module 116 also determines temporally non-overlapping healthcare service episodes (506). A healthcare service episode may comprise a specific period of time and include all of the healthcare service events that occur within the specific time period. In some examples, episode module 116 may determine a healthcare service episode based on a trigger healthcare service event. For example, episode module 116 may determine the beginning of a healthcare service episode on the date of occurrence of one of the trigger healthcare service events. In other examples, the healthcare service episode may not begin exactly on the date of the trigger healthcare service event. Rather, the healthcare service episode may comprise a time period surrounding the date of the trigger healthcare service event. For example, a healthcare service episode may comprise a time period including one month before the trigger healthcare service event and two months after the healthcare service event.

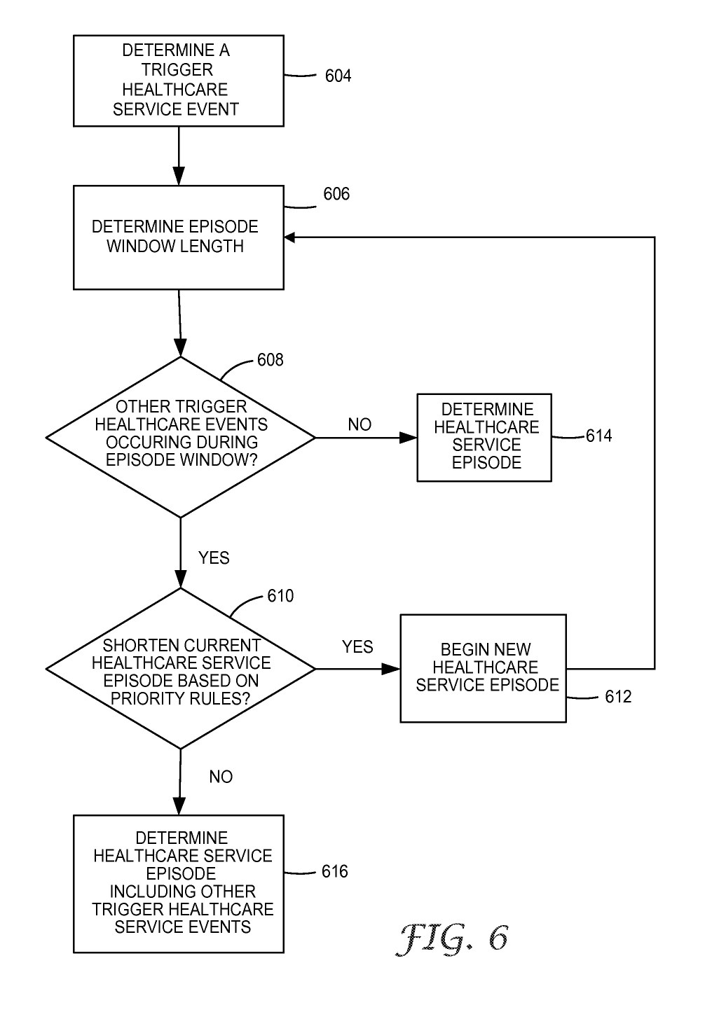

FIG. 6 is another flow diagram illustrating a technique consistent with this disclosure. Similarly to FIG. 5, episode module 116 receives patient healthcare data 118 (602). Episode module 116 further determines trigger healthcare events, in accordance with earlier description surrounding FIG. 1 (604).

Episode module 116 also determined an episode window length (606). In at least one example, episode module 116 may determine an episode window length based on a predefined time period, such as three months. In other examples, episode module 116 may determine an episode window length which varies based on the specific determined trigger healthcare service event. In still other examples, episode module 116 may determine the episode window length based on received input. For example, user interface module 117 may output a user interface (UI) 132 to output device 130. A user may then enter a specified time period into UI 132. UI module 117 may then communicate the input timer period to episode module 116 for use as the determined episode window length. Consequently, episode module 116 may determine a trigger healthcare service event and an episode window length associated with each healthcare service episode.

Episode module 116 may further determine whether another trigger healthcare service event occurs within the determined episode window for the first healthcare service event (608). If episode module 116 does determine another trigger healthcare service event occurring in the current healthcare service episode window (yes of 608), episode module 116 may then determine whether to shorten the current healthcare service episode based on trigger healthcare service event priority rules (610). For example, certain trigger healthcare service events will take priority over other trigger healthcare service events for determining whether to shorten the episode window of a current healthcare service episode and begin a new healthcare service episode. If the priority rules indicate the other trigger healthcare service event takes priority over the trigger healthcare service event of the current healthcare service episode (yes of 610), then episode module 116 shortens the current healthcare service episode window and begins a new healthcare service episode based on the other trigger healthcare service event (612). The method then repeats starting at block 606, where episode module 116 determines an episode window length for the new, current trigger healthcare service event.

If the priority rules indicate the other trigger healthcare service event does not take priority over the trigger healthcare service event of the current healthcare service episode (no of 610), then episode module 116 does not shorten the current healthcare service episode window. Instead, episode module 116 determines the current healthcare service episode by including all the healthcare service events, including the other trigger healthcare service event, in the current healthcare service episode (616).

If episode module 116 does not determine that another trigger healthcare service event occurs within the current healthcare service episode window (no of 608), episode module 116 may then simply determine the healthcare service episode (614). As discussed above, determining a healthcare service episode may include all of the healthcare service events occurring within the current episode window within the current healthcare service episode.

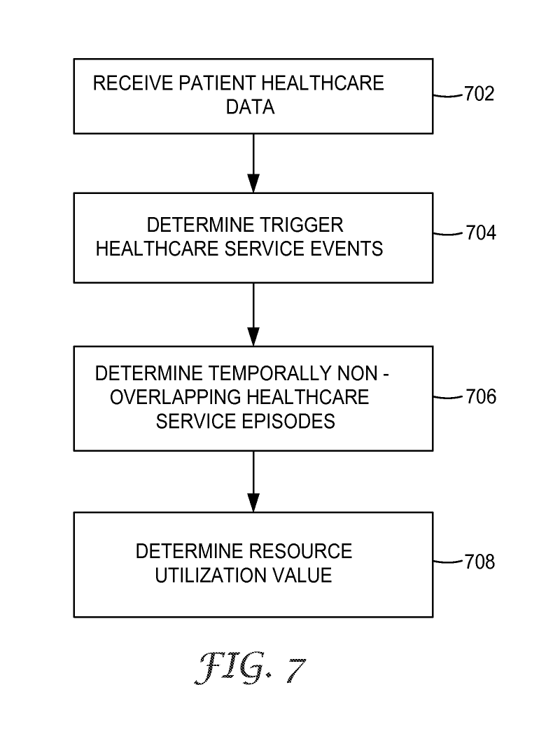

FIG. 7 is another flow diagram illustrating a technique consistent with this disclosure. Similarly to FIG. 5, episode module 116 receives patient healthcare data 118 (702), determines trigger healthcare service events (704), and determines temporally non-overlapping healthcare service episodes (706).

However, as described now with respect to FIG. 2, resource utilization module 223 may further determine resource utilization values (708). In some examples, resource utilization module 223 may determine a total level of resource utilization based on the determined patient healthcare service episodes. For example, resource utilization module 223 may receive a single healthcare service episode from healthcare service episodes 220. This healthcare service episode may include a number of healthcare service events. In addition to including the information described with respect to patient healthcare data 118, patient healthcare data 218 may also include financial metrics such as charge amounts or reimbursement amounts associated with the healthcare service events included in patient healthcare data 218. Based on this charge and reimbursement information associated with the individual healthcare service events comprising the healthcare service episode, resource utilization module 223 may determine a resource utilization value for the healthcare service episode. In some examples, resource utilization module 223 may determine resource utilization values for determined healthcare service episodes based on selection parameters received from a user. For example, user interface module 217 may output a user interface (UI) 232 to output device 230. A user, viewing UI 232, may enter selection parameters. User interface module 217 may then communicate the selection parameters to episode module 216.

Various selection parameters may comprise resource type categories to be included in the resource utilization determination. For example, resource type selection parameters may comprise categories such as an Inpatient Hospital Facility category, a Hospice Facility category, a Skilled Nursing Facility category, an Extended Care Facility category, an Outpatient Hospital Facility category, an Outpatient ER Facility category, an Outpatient a Surgery Facility category, a Home Health category, a Professional Ancillary category, a Professional Inpatient category, a Professional Outpatient category, a Professional Extended Care category, a Professional Office category, a Retail Pharmacy category, an Outpatient/Professional Pharmacy category, an Outpatient/Professional DME category, an Outpatient/Professional Laboratory category, an Outpatient/Professional Diagnostic Radiology category, and a Miscellaneous Facility category. As described previously, patient healthcare data 218 may comprise information regarding charge amounts or reimbursement amounts. Other selection parameters may include CRG status parameters such as a CRG window length parameter. In such examples, the CRG window length parameter may be a specified time period surrounding the entered specific healthcare service episode or trigger healthcare service event. Resource utilization module 223 may use this CRG window parameter in further processing the healthcare service episodes and determining CRG assignments and severity level indicators associated with the healthcare service episode. Based on all of these selection parameters, resource utilization module 223 may determine a resource utilization value for one or more healthcare service episodes.

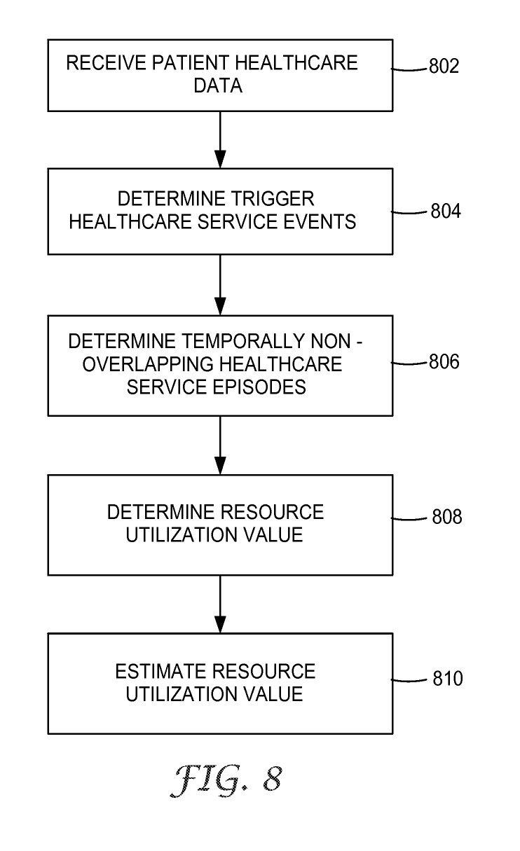

FIG. 8 is another flow diagram illustrating a technique consistent with this disclosure. Similarly to FIG. 7, episode module 116 receives patient healthcare data 118 (802), determines trigger healthcare service events (804), and determines temporally non-overlapping healthcare service episodes (806). Further similarly to FIG. 7, another module, such as resource utilization module 223, determines resource utilization values (808).

However, resource utilization module 223 further estimates resource utilization values (810). For example, resource utilization module 223 may determine resource utilization values for all of the selected healthcare service episodes and determine an average resource utilization value. As described previously with respect to FIG. 2, resource utilization module 223 may categorize the determined resource utilization values based on CRG assignments, severity level indicators, and/or risk adjustment factors. Based on these determined values, resource utilization module 223 may further determine an average resource utilization value for the specific healthcare service episode. This average resource utilization value may be an estimate of future resource utilization for those specific healthcare service episodes. Further, resource utilization module 223 may determine adjustments to the estimate based on determined CRG assignment, severity indicator, and/or risk adjustment factor for the specific healthcare service episode. For instance, a high risk adjustment factor may indicate that a particular episode may utilize more resources than the determined average similar healthcare episode. Therefore, resource utilization module 223 may estimate a higher resource utilization value for the specific healthcare service episode.

The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and does not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

These and other examples are within the scope of the following claims.

What is claimed:

1. A method of processing patient healthcare data, via one or more computers, the method comprising:
receiving, at the one or more computers, dated patient healthcare data associated with a patient, wherein the dated patient healthcare data comprises information about one or more of: diagnosed conditions, delivered services or procedures, severity indicators, or resource utilization data associated with any delivered services or procedures;
determining, via the one or more computers, trigger healthcare service events based on the patient healthcare data, wherein the trigger healthcare service events comprise one or more of inpatient admissions, outpatient procedures, or outpatient healthcare services; and
determining, via the one or more computers, one or more temporally non-overlapping healthcare service episodes based on the determined trigger healthcare service events.

2. The method of claim 1, wherein determining the one or more temporally non-overlapping healthcare service episodes based on the determined trigger healthcare service events comprises:
determining, via the one or more computers, an episode window length and a first trigger healthcare service event associated with a first temporally non-overlapping healthcare service episode;
determining, via the one or more computers, whether a second trigger healthcare event occurs within the episode window associated with the first healthcare service episode; and
if a second trigger healthcare service event occurs within the episode window associated with the first healthcare service episode:
comparing, via the one or more computers, a hierarchy rank of the first trigger healthcare service event with a hierarchy rank of the second trigger healthcare service event; and
terminating the first healthcare service episode if the hierarchy rank of the second trigger healthcare service event is greater than the hierarchy rank of the first trigger healthcare service event, or subsuming the second trigger healthcare service event into the first healthcare service episode if the hierarchy rank of the second trigger healthcare service event is lower than the hierarchy rank of the first trigger healthcare service event.

3. The method of claim 1, wherein the method further comprises:
determining, via the one or more computers, a patient profile based on the determined non-overlapping healthcare service episodes, wherein the patient profile comprises a sequence of temporally non-overlapping healthcare service episodes.

4. The method of claim 1, wherein determining, via the one or more computers, the one or more non-overlapping healthcare service episodes comprises:
determining, via the one or more computers, an episode window length;
determining, via the one or more computers, an episode window, wherein the episode window comprises a series of dates encompassing a trigger healthcare service event and a series of dates the length of the determined episode window length; and
determining, via the one or more computers, a temporally non-overlapping healthcare service episode encompassing the determined episode window and comprising all healthcare service events within the determined episode window.

5. The method of claim 4, wherein determining the episode window length comprises one of:
receiving, at the one or more computers, a predetermined time period,
receiving, at the one or more computers, input comprising a time period, or
receiving, at the one or more computers, a predetermined time period associated with a particular trigger healthcare service event.

6. The method of claim 1, wherein the method further comprises:
determining a resource utilization value associated with a temporally non-overlapping healthcare service episode.

7. The method of claim 6, wherein determining a resource utilization value associated with a temporally non-overlapping healthcare service episode comprises determining the resource utilization value based at least in part on received input selections comprising one or more of: a trigger healthcare service event parameter, an episode window parameter, a CRG window parameter, patient characteristic data, and resource type parameters.

8. The method of claim 1, wherein the method further comprises:
determining an estimated resource utilization value associated with a temporally non-overlapping healthcare service episode.

9. The method of claim 8, wherein determining an estimated resource utilization value associated with a temporally non-overlapping healthcare service episode comprises determining the estimated resource utilization value based at least in part on an average of resource utilization values.

10. The method of claim 1, wherein the method further comprises:
determining a resource utilization value over a received time period selection.

11. The method of claim 10, wherein determining a resource utilization value over a received time period selection comprises determining the resource utilization value based at least in part on:
a received time period selection, and
received input selections comprising one or more of: an episode window parameter, a CRG window parameter, patient characteristic data, and resource type parameters.

12. The method of claim 1, wherein the method further comprises:
determining an estimated resource utilization value over a received time period selection.

13. The method of claim 12, wherein determining an estimated resource utilization value over a received time period selection comprises determining the estimated resource utilization value based at least in part on an average of resource utilization values.

14. A computerized healthcare system for processing healthcare data, the system comprising a computer that includes a processor and a memory, wherein the processor is configured to:
receive dated patient healthcare data associated with a patient, wherein the dated patient healthcare data comprises information about one or more of diagnosed conditions, delivered services or procedures, severity indicators, or resource utilization data associated with any delivered services or procedures;
determine trigger healthcare service events based on the patient healthcare data, wherein the trigger healthcare service events comprise one or more of inpatient admissions, outpatient procedures, or outpatient healthcare services; and
determine one or more temporally non-overlapping healthcare service episodes based on the determined trigger healthcare service events.

15. The system of claim 14, where in determining one or more temporally non-overlapping healthcare service episodes based on the determined trigger healthcare service events, the processor is further configured to:
determine an episode window length and a first trigger healthcare service event associated with a first temporally non-overlapping healthcare service episode;
determine whether a second trigger healthcare event occurs within the episode window associated with the first healthcare service episode; and
if a second trigger healthcare service event occurs within the episode window associated with the first healthcare service episode:
compare a hierarchy rank of the first trigger healthcare service event with a hierarchy rank of the second trigger healthcare service event; and
terminatw the first healthcare service episode if the hierarchy rank of the second trigger healthcare service event is greater than the hierarchy rank of the first trigger healthcare service event, or subsuming the second trigger healthcare service event into the first healthcare service episode if the hierarchy rank of the second trigger healthcare service event is lower than the hierarchy rank of the first trigger healthcare service event.

16. The system of claim 14, wherein the processor is further configured to:
determine a patient profile based on the determined non-overlapping healthcare service episodes, wherein the patient profile comprises a sequence of temporally non-overlapping healthcare service episodes.

17. The system of claim 14, wherein determining the one or more non-overlapping healthcare service episodes, the processor is further configured to:
determine an episode window length;
determine an episode window, wherein the episode window begins with a trigger healthcare service event and runs for the length of the determined episode window length; and
determine a temporally non-overlapping healthcare service episode encompassing the determined episode window and comprising all healthcare service events within the determined episode window.

18. The system of claim 17, wherein determining the episode window length, the processor is further configured to:
receive a predetermined time period,
receive input comprising a time period, or
receive a predetermined time period associated with a particular trigger healthcare service event.

19. The system of claim 14, wherein the processor is further configured to:
determine a resource utilization value associated with a temporally non-overlapping healthcare service episode.

20. The system of claim 19, wherein determining a resource utilization value associated with a temporally non-overlapping healthcare service episode, the processor is further configured to determine the resource utilization value based at least in part on received input selections comprising one or more of: an episode window parameter, a CRG window parameter, patient characteristic data, and resource type parameters.

21. The system of claim 14, wherein the processor is further configured to:
determine an estimated resource utilization value associated with a temporally non-overlapping healthcare service episode.

22. The system of claim 21, wherein determining an estimated resource utilization value associated with a temporally non-overlapping healthcare service episode, the processer is further configured to determine the estimated resource utilization value based at least in part on an average of resource utilization values.

23. The system of claim 14, wherein the processor is further configured to:
determine a resource utilization value over a received time period selection.

24. The system of claim 23, where in determining a resource utilization value over a received time period selection, the processor is further configured to determine the resource utilization value based at least in part on:
a received time period selection, and
received input selections comprising one or more of: an episode window parameter, a CRG window parameter, patient characteristic data, and resource type parameters.

25. The system of claim 14, wherein the processor is further configured to:
determine an estimated resource utilization value over a received time period selection.

26. The system of claim 25, wherein determining an estimated resource utilization value for treatment of the patient over a received time period selection, the processor is further configured to determine the estimated resource utilization value based at least in part on an average of resource utilization values.

27. A device for processing healthcare data, the device comprising:
means for receiving, at the one or more computers, dated patient healthcare data associated with a patient, wherein the dated patient healthcare data comprises information about one or more of diagnosed conditions, delivered services or procedures, severity indicators, or resource utilization data associated with any delivered services or procedures;
means for determining, via the one or more computers, trigger healthcare service events based on the patient healthcare data, wherein the trigger healthcare service events comprise one or more of inpatient admissions, outpatient procedures, or outpatient healthcare services; and
means for determining, via the one or more computers, one or more temporally non-overlapping healthcare service episodes based on the determined trigger healthcare service events.

28. A computer readable storage medium comprising instructions that when executed in a processor cause the processor to process healthcare data, wherein upon execution the instructions cause the processor to:
receive dated patient healthcare data associated with a patient, wherein the dated patient healthcare data comprises information about one or more of diagnosed conditions, delivered services or procedures, severity indicators, or resource utilization data associated with any delivered services or procedures;
determine trigger healthcare service events based on the patient healthcare data, wherein the trigger healthcare service events comprise one or more of inpatient admissions, outpatient procedures, or outpatient healthcare services; and
determine one or more temporally non-overlapping healthcare service episodes based on the determined trigger healthcare service events.
